(19) United States
(12) Patent Application Publication
(10) Pub. No.: US 2026/0351626 A1
(43) Pub. Date: Nov. 5, 2026

(54) ALKALINE IONIC LIQUID ELECTROLYTE, PREPARATION METHOD THEREOF, AND USE METHOD THEREFOR IN ALUMINUM PRIMARY CELL

(71) Applicant: Wuhan University of Technology, Wuhan (CN)

(72) Inventors: Jiashen MENG, Wuhan (CN); Yibo SONG, Wuhan (CN); Kai LUO, Wuhan (CN); Liqiang MAI, Wuhan (CN)

(21) Appl. No.: 19/714,829

(22) Filed: Jun. 22, 2026

(30) Foreign Application Priority Data
Nov. 12, 2025 (CN) 202511650108.X

(51) Int. Cl. H01M 6/16; H01M 4/02; H01M 4/46; H01M 4/583

(52) U.S. Cl. CPC H01M 6/162; H01M 4/463; H01M 4/5835; H01M 2004/027; H01M 2004/028

(57) ABSTRACT

The present disclosure belongs to the technical field of aluminum based primary cell and discloses an alkaline ionic liquid electrolyte obtained by coordinating AlCl₃ with Cl⁻ in 1-ethyl-3-methylimidazolium chloride and alkali metal chloride salt. A general formula for raw material components is AₐE_{b}X_{c}, wherein A is the aluminum chloride, E is the 1-ethyl-3-methylimidazolium chloride, and X is the alkali metal chloride salt, and 0.4≤a≤0.8, 0.9≤b≤1, and 0≤c≤0.1. The present disclosure proposes for a first time use of alkaline ionic liquid electrolyte instead of traditional acidic ionic liquid electrolyte, changing composition of active ions/molecular groups, promoting stable existence of free Cl⁻ and alkali metal cations, which can significantly improve electrochemical performances of aluminum fluorinated carbon and aluminum sulfur primary cells, exhibiting higher discharge specific capacity, discharge voltage plateau, and excellent rate performances, effectively balancing advantages of high energy density, excellent safety performance, low cost, and wide operating temperature range.

### TECHNICAL FIELD

The present disclosure belongs to the technical field of aluminum based primary cell, and specifically relates to an alkaline ionic liquid electrolyte, preparation method thereof, and use method therefor in aluminum primary cell.

### BACKGROUND

Fluorinated carbon material, due to its characteristics of high theoretical specific capacity, excellent chemical stability, and thermal stability, enables lithium fluorinated carbon primary cell (primary cell) to achieve high energy density and low self-discharge rate, making it a stable and reliable choice of power source. Similarly, sulfur, as a positive electrode material, has shown great potential in high-energy density applications of lithium sulfur primary cell due to its advantages of extremely high theoretical specific capacity (~1675 mAh/g) and low cost. Thanks to these characteristics, lithium fluorinated carbon primary cell and lithium sulfur primary cell have demonstrated sustained and significant application value in specific fields that strictly require energy density, reliability, and long-term stability.

However, the high cost and limited reserves of elemental lithium limit its promotion in large-scale energy storage applications. In contrast, aluminum cell is considered a promising energy storage system for the next generation due to low cost of the aluminum negative electrode, abundant crustal reserves of elemental aluminum, and high theoretical volumetric capacity. Aluminum fluorinated carbon primary cell and aluminum sulfur primary cell combine advantages of aluminum negative electrode and fluorinated carbon or sulfur positive electrode, which is expected to overcome limitations of lithium based cell in terms of cost and resource reserves, and provide new solutions for high-performance energy storage systems.

In the system of aluminum fluorinated carbon primary cell and aluminum sulfur primary cell, electrolyte is the key to achieving high performances. As a medium and ion transport carrier for electrochemical reactions, electrolyte not only directly participates in the oxidation-reduction reactions of cathode and anode, but also determines electrochemical performances of the entire cell system. Al³⁺ ion has a small ionic radius and high charge density, involving complex three-electron transfer process, which poses higher requirements for ion conductivity and reaction kinetics of electrolyte. Existing aluminum cell typically uses acidic ionic liquid prepared from aluminum chloride (AlCl₃) and 1-ethyl-3-methylimidazolium chloride ([EMIM]Cl) as electrolyte. Under acidic conditions, anions in the liquid electrolyte are mainly AlCl₄⁻ and Al₂Cl₇⁻. During the charging process of secondary cell, the presence of Al₂Cl₇⁻ ion clusters is crucial for ensuring effective deposition of aluminum ions on the negative electrode. Therefore, existing researches typically use acidic ionic liquid electrolyte.

However, when using acidic liquid electrolyte to prepare aluminum fluorinated carbon primary cell, the conversion reaction kinetics are slow and face significant kinetic limitations, resulting in issues of an actually too low discharge voltage plateau (0.1~0.2 V), insufficient specific capacity (<100 mAh/g, far below the theoretical capacity of fluorinated carbon), and poor rate performance, which are difficult to meet practical application needs. Similarly, aluminum sulfur primary cell exhibits a lower discharge voltage plateau (0.4~0.5 V) and poor rate performance in the system of acidic ionic liquid electrolyte due to limited reaction kinetics in sulfur positive electrode, which limits its effectiveness in practical applications.

Further development of aluminum ionic electrolyte having excellent reaction kinetics to promote high specific capacity and excellent rate performance in aluminum fluorinated carbon primary cell and aluminum sulfur primary cell is a key prerequisite for constructing aluminum based primary cell having high-energy density and high-power density.

### SUMMARY

To address the issues and shortcomings of existing technology, the present disclosure proposes an alkaline ionic liquid electrolyte and a novel aluminum based primary cell system based on the alkaline ionic liquid electrolyte (which is a system of aluminum fluorinated carbon primary cell and aluminum sulfur primary cell). The use of alkaline ionic liquid electrolyte instead of traditional acidic ionic liquid electrolyte, while introducing alkali metal cations into the liquid electrolyte, can significantly improve electrochemical performances of aluminum based primary cell, exhibiting higher discharge specific capacity, discharge voltage plateau, and excellent rate performance, while effectively balancing advantages of excellent safety performance, low cost, and wide operating temperature range.

The first objective of the present disclosure is to provide an alkaline ionic liquid electrolyte, which directionally optimizes the solvation structure of the liquid electrolyte, changes the composition of active ions/molecular groups, promotes the stable existence of free Cl⁻ ions and alkali metal cations, and significantly improves and optimizes the kinetic effects of electrochemical reactions of the system of aluminum based primary cell.

The second objective of the present disclosure is to provide a preparation method of alkaline ionic liquid electrolyte, which has advantages of simple operation, short process flow, low preparation cost, and suitability for large-scale production.

The third objective of the present disclosure is to provide a novel aluminum fluorinated carbon primary cell having a high specific energy, which utilizes aforementioned alkaline ionic liquid electrolyte to effectively accelerate electrochemical reaction kinetics, thereby achieving excellent characteristics such as high discharge specific capacity, excellent rate performance, and a wide operating temperature range.

The fourth objective of the present disclosure is to provide an aluminum sulfur primary cell having high rate performance and high discharge plateau, which utilizes aforementioned alkaline ionic liquid electrolyte to effectively enhance the kinetic effects of electrochemical reactions.

In order to achieve aforementioned objectives of the present disclosure, following technical solutions are adopted.

An alkaline ionic liquid electrolyte, which is generated by coordinating AlCl₃ as a Lewis acid with Cl⁻ (Lewis base) in [EMIM]Cl and alkali metal chloride salt. A general formula for raw material components of the alkaline ionic liquid electrolyte is AₐE_{b}X_{c}, where A is aluminum chloride (AlCl₃), E is 1-ethyl-3-methylimidazolium chloride ([EMIM]Cl), and X is alkali metal chloride salt, specifically selected from at least one of lithium chloride (LiCl), sodium chloride (NaCl), potassium chloride (KCl), rubidium chloride (RbCl), caesium chloride (CsCl), etc; a is a molar ratio of the aluminum chloride, b is the molar ratio of the 1-ethyl-3-methylimidazolium chloride, and c is the molar ratio of the alkali metal chloride salt, and 0.4≤a≤0.8, 0.9≤b≤1, and 0≤c≤0.1. The alkaline ionic liquid electrolyte exhibits a clear liquid state at temperatures above its melting point.

The solvation structure of the alkaline ionic liquid electrolyte is influenced by the ratio of the aluminum chloride (AlCl₃) to the 1-ethyl-3-methylimidazolium chloride ([EMIM]Cl) and the alkali metal chloride. The specific reaction equation is as follows:

aAlCl₃+b[EMIM]Cl+cXCl→aAlCl₄⁻+b[EMIM]⁺+cX⁺+(b+c−a)Cl⁻.

The obtained alkaline ionic liquid electrolyte contains anions Cl⁻ and AlCl₄⁻, and cations [EMIM]⁺ and X⁺ (which is one or more of Li⁺, Na⁺, K⁺, Rb⁺, Cs⁺, etc.). As value a increases from 0.4 to 0.8, the concentration of Cl⁻ in the electrolyte gradually decreases, while the concentration of AlCl₄⁻ correspondingly increases.

A preparation method of the aforementioned alkaline ionic liquid electrolyte is also provided, which includes following steps: under inert atmosphere and anhydrous conditions, accurately weighing the aluminum chloride (AlCl₃), the 1-ethyl-3-methylimidazolium chloride ([EMIM]Cl), and the alkali metal chloride salt (which is one or more of LiCl, NaCl, KCl, RbCl, CsCl, etc.) according to a ratio; then, under continuous stirring conditions, adding the aluminum chloride to a mixture of the [EMIM]Cl and the alkali metal chloride salt, and stirring and reacting to generate a clear liquid, thus obtaining the alkaline ionic liquid electrolyte.

In some embodiments, the [EMIM]Cl needs to be pre-treated to remove crystal water before use.

In some embodiments, pre-treatment can be carried out using methods such as high-temperature vacuum drying, molecular sieve drying, or heat treatment drying.

The melting point of the alkaline ionic liquid electrolyte obtained from above scheme is −30~−20 °C, which can exhibit a wider working temperature range. After being left at −20 °C for 24 hours, traditional acidic liquid electrolytes usually solidify, but the alkaline ionic liquid electrolyte of the present disclosure still remains in a liquid state.

The present disclosure further provides an aluminum primary cell based on the aforementioned alkaline ionic liquid electrolyte. The aluminum primary cell includes following key components: an aluminum negative electrode, the alkaline ionic liquid electrolyte (liquid electrolyte) obtained from above scheme, a separator, and a positive electrode material.

In above scheme, the aluminum primary cell is an aluminum fluorinated carbon primary cell or an aluminum sulfur primary cell. The positive electrode material of the aluminum fluorinated carbon primary cell is a fluorinated carbon based positive electrode material (the aluminum fluorinated carbon primary cell), and the positive electrode material of the aluminum sulfur primary cell is a sulfur-containing conductive positive electrode material (the aluminum sulfur primary cell).

In some embodiments, the fluorinated carbon based positive electrode includes fluorinated carbon materials and conductive materials. The fluorinated carbon materials include but are not limited to at least one of fluorinated graphite, fluorinated graphene, fluorinated carbon fiber, fluorinated carbon nanotube, etc., and the conductive materials include but are not limited to at least one of graphene, reduced graphene oxide, carbon nanotube, carbon fiber material, porous carbon material, carbon black, activated carbon, conductive polymer, etc.

In some embodiments, in the fluorinated carbon based cathode material, at least one of polyaniline, polypyrrole, polythiophene, etc. can be selected as the conductive polymer.

Preferably, in the positive electrode of the aluminum fluorinated carbon primary cell, the areal loading of the fluorinated carbon materials is ≥1.5 mg/cm², preferably 1.5~30 mg/cm².

In above scheme, the sulfur-containing conductive positive electrode material in the aluminum sulfur primary cell includes sulfur-containing materials and conductive materials.

Preferably, the sulfur-containing materials include at least one of elemental sulfur, sulfurized polyacrylonitrile, sulfur selenium compounds, aluminum sulfur compounds, etc., and the conductive materials include at least one of graphene, reduced graphene oxide, carbon nanotube, carbon fiber material, porous carbon material, carbon black, activated carbon, conductive polymer, etc.

Preferably, in the positive electrode of the aluminum sulfur primary cell, the areal loading of the elemental sulfur is ≥1.5 mg/cm², preferably 1.5~8 mg/cm².

In some embodiments, the alkaline ionic liquid electrolyte is in liquid state and is utilized to fully infiltrate the positive electrode, the separator, and aluminum negative electrode.

Preferably, the operating temperature range of the aluminum primary cell (the aluminum fluorinated carbon primary cell or the aluminum sulfur primary cell) is ~10-100 °C.

The present disclosure further provides a preparation method of the aforementioned aluminum primary cell, which includes following steps: obtaining a positive electrode material (which is a conversion type), a positive-electrode current collector, the aluminum negative electrode, and the separator; mixing the positive electrode material with a conductive agent and a binder and coating the positive electrode material on the surface of the positive-electrode current collector to obtain the positive electrode; and then assembling and packaging the positive electrode, the aluminum negative electrode, the separator, and the alkaline ionic liquid electrolyte.

In some embodiments, the aluminum fluorinated carbon primary cell and the aluminum sulfur primary cell can be applied in fields of portable electronic devices (smart glasses, wireless intercoms, etc.), military and aerospace (satellites), implantable medical instruments (pacemakers, nerve stimulators, etc.), Internet of Things (IoT) terminals, and long-term monitoring systems (sensors, smart home devices, etc.).

Compared with the prior art, beneficial effects of the present disclosure are as follows.

(1) The present disclosure optimizes the solvation structure of the alkaline ionic liquid electrolyte in a targeted manner, and the stable presence of free Cl⁻ and metal cations (Li⁺, Na⁺, K⁺, Rb⁺, Cs⁺, etc.) in the obtained electrolyte can effectively promote breaking of C—F bonds during the discharge process of the aluminum fluorinated carbon primary cell. At the same time, the stable presence of free Cl⁻ and metal cations in the obtained electrolyte can promote breaking of S—S bonds during the discharge process of the aluminum sulfur primary cell, thereby significantly improving electrochemical performances of aluminum fluorinated carbon primary cell and aluminum sulfur primary cell, making them possess performances of high discharge voltage plateau, excellent discharge specific capacity, and outstanding and high rates.

(2) The alkaline ionic liquid electrolyte provided by the present disclosure has a significantly lower melting point compared to traditional acidic ionic liquid electrolytes, and can exhibit a wider operating temperature range. Due to the presence of free Cl⁻ ions, the coordination between ions in the alkaline ionic liquid electrolyte is enhanced, leading to structural disorder and hindering crystal formation. With temperature changes, the alkaline ionic liquid electrolyte exhibits a glass transition and can still maintain a liquid state over a wide temperature range.

(3) The aluminum fluorinated carbon primary cell based on the alkaline ionic liquid electrolyte described in the present disclosure can achieve the theoretical specific capacity of fluorinated carbon (up to 865 mAh/g) with a stable discharge plateau (1.1 V), significantly superior to the aluminum fluorinated carbon primary cell based on traditional acidic ionic liquid electrolytes (the discharge plateau of which typically only 0.1~0.2 V, and the discharge specific capacity of which is less than 100 mAh/g).

(4) The aluminum sulfur primary cell based on the alkaline ionic liquid electrolyte provided by the present disclosure exhibits a high discharge voltage plateau and excellent high-rate discharge performance, which can meet the fast discharge requirements of 1.5 C. In the positive electrode, the high specific capacity of sulfur is fully utilized, thereby significantly improving the energy density of the cell.

(5) The aluminum fluorinated carbon primary cell and the aluminum sulfur primary cell provided by the present disclosure further demonstrate excellent safety performances. In the nail penetration test, the temperature fluctuation amplitude of the aluminum fluorinated carbon pouch cell and the aluminum sulfur pouch cell does not exceed 0.3 °C, demonstrating excellent thermal stability. At the same time, no potential hazardous phenomena such as cell expansion, smoking, or combustion are observed.

(6) The present disclosure can significantly reduce manufacturing cost of the aluminum sulfur primary cell and has significant economic and environmental benefits.

### BRIEF DESCRIPTION OF THE DRAWINGS

FIG. 1 shows Raman test results of alkaline ionic liquid electrolytes (A_{0.5}E₁X₀, A_{0.7}E₁X₀) and acidic liquid electrolyte (A_{1.3}E₁X₀).

FIG. 2 shows constant current discharge test results of aluminum fluorinated graphite primary cell (Application Example 1) prepared using alkaline ionic liquid electrolyte (A_{0.4}E_{0.95}X_{0.08}) obtained in Implementation Example 1.

FIG. 3 shows constant current discharge test results of aluminum Ketjen black/sulfur primary cell (Application Example 2) prepared using alkaline ionic liquid electrolyte (A_{0.4}E_{0.95}X_{0.08}) obtained in Implementation Example 1.

FIG. 4 shows constant current discharge test results of aluminum fluorinated graphene primary cell (Application Example 3) prepared using alkaline ionic liquid electrolyte (A_{0.5}E_{0.95}X_{0.05}) obtained in Implementation Example 2.

FIG. 5 shows constant current discharge test results of aluminum carbon nanotube/sulfur cell (Application Example 4) prepared using alkaline ionic liquid electrolyte (A_{0.5}E_{0.95}X_{0.05}) obtained in Implementation Example 2.

FIG. 6 shows constant current discharge test results of aluminum fluorinated carbon fiber primary cell (Application Example 5) prepared using alkaline ionic liquid electrolyte (A_{0.7}E_{0.9}X_{0.1}) obtained in Implementation Example 3.

FIG. 7 shows constant current discharge test results of aluminum carbon nanotube/sulfur cell (Application Example 6) prepared using alkaline ionic liquid electrolyte (A_{0.7}E_{0.9}X_{0.1}) obtained in Implementation Example 4.

FIG. 8 shows constant current discharge test results of aluminum fluorinated carbon fiber primary cell (Application Example 7) prepared using alkaline ionic liquid electrolyte (A_{0.8}E_{0.9}X_{0.1}) obtained in Implementation Example 5 under high-active material loading (13.5 mg/cm²).

FIG. 9 shows constant current discharge test results of aluminum fluorinated carbon fiber primary cell (Application Example 8) prepared using alkaline ionic liquid electrolyte (A_{0.8}E_{0.9}X_{0.1}) obtained in Implementation Example 6 at a high current density (100 mA/g).

FIG. 10 shows constant current discharge test results of aluminum Ketjen black/sulfur primary cell based on alkaline ionic liquid electrolyte (A_{0.5}E_{0.95}X_{0.05}) obtained in Implementation Example 7 at a high current density (1 C).

FIG. 11 shows constant current discharge test results of aluminum fluorinated carbon fiber primary cell obtained using acidic ionic liquid electrolyte (A_{1.3}E₁X₀) in Comparison Example 1.

FIG. 12 shows constant current discharge test results of aluminum Ketjen black/sulfur primary cell obtained using acidic ionic liquid electrolyte (A_{1.3}E₁X₀) in Comparison Example 2.

FIG. 13 shows constant current discharge test results of aluminum fluorinated carbon fiber primary cell obtained using neutral ionic liquid electrolyte (A₁E₁X₀) in Comparison Example 3.

FIG. 14 shows constant current discharge test results of aluminum fluorinated carbon fiber primary cell obtained using acidic ionic liquid electrolyte (A_{1.3}E_{0.8}X_{0.2}) in Comparison Example 4.

### DETAILED DESCRIPTION

The technical solution of the present disclosure will be clearly and completely described below in conjunction with accompanying drawings and specific embodiments. However, those skilled in the art will understand that embodiments described below are part of embodiments of the present disclosure, not all of them, and are only used to illustrate the present disclosure and should not be considered as limiting the scope of the present disclosure. Based on the embodiments of the present disclosure, all other embodiments obtained by those ordinary skilled in the art without creative labor are within the scope of protection of the present disclosure. If specific conditions are not specified in the embodiments, conventional conditions or conditions recommended by manufacturers are followed. Reagents or instruments used without specifying manufacturers are conventional products that can be obtained through commercial purchase.

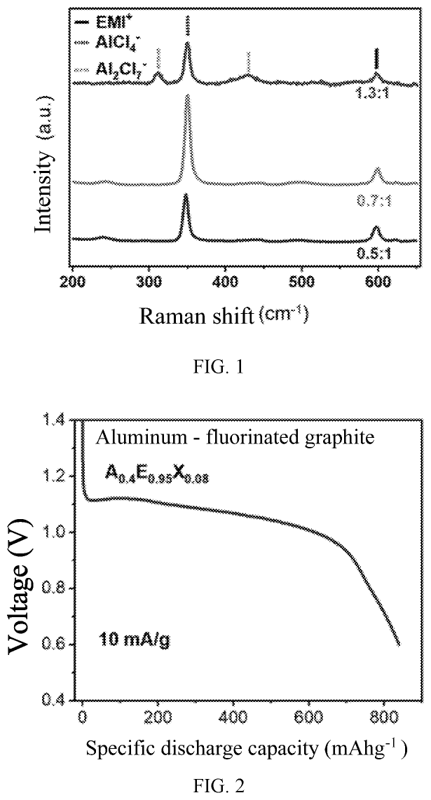

FIG. 1 shows Raman test results of alkaline ionic liquid electrolytes (A_{0.5}E₁X₀, A_{0.7}E₁X₀) and acidic ionic liquid electrolyte (A_{1.3}E₁X₀) obtained under different ratios of AlCl₃ and [EMIM]Cl. The results indicate that ion groups in the alkaline ionic liquid electrolytes and neutral electrolytes are only AlCl₄⁻ (Raman test usually cannot detect individual ions such as Cl⁻), while the acidic liquid electrolyte contains AlCl₄ and Al₂Cl₇⁻, that is, the acidic liquid electrolyte has a different structure from the alkaline liquid electrolyte obtained in the present disclosure.

In following implementation examples, all operations are performed inside an argon-filled glove box (conditions of which are O₂<0.01 ppm and H₂O<0.01 ppm).

Before using EMICl, the EMICl is dried at 160 °C for 12 hours, then cooled down, and grinded into powder for later use.

### Implementation Example 1

An alkaline ionic liquid electrolyte, the preparation method of which includes following steps:

Aluminum chloride (AlCl₃), 1-methyl-3-ethylimidazole chloride (EMICl), and lithium chloride (LiCl) are firstly weighed in a molar ratio of 0.4:0.95:0.08. The aluminum chloride (AlCl₃) is added to a mixture of the 1-methyl-3-ethylimidazole chloride and the lithium chloride (LiCl) in batches (5~10 times in total) within 30~60 minutes at room temperature, and they are stirred (200~600 rpm) to fully mix and liquefy the components. After adding the aluminum chloride, they are continuously stirred and reacted for 30~60 minutes until the system is completely liquefied and formed a clear ionic liquid electrolyte with a melting point of −25~−20 °C.

### Application Example 1

The alkaline ionic liquid electrolyte obtained in Implementation Example 1 is applied to prepare an aluminum fluorinated carbon primary cell, which uses a Swagelok-type sealing structure. The separator, the positive electrode, and the negative electrode are cut according to the cell model design. The specific preparation method includes following steps: CFₓ positive electrode material (fluorinated graphite CFₓ, x=1.08, which is stable in the obtained liquid electrolyte system), conductive carbon black, and polytetrafluoroethylene (PTFE) are mixed in a mass ratio of 7:2:1, pressed and cut to prepare the positive electrode sheet, and aluminum sheet is used as the negative electrode, the obtained alkaline ionic liquid electrolyte is used as the liquid electrolyte, and glass fiber is used as the separator, then they are assembled and packaged.

FIG. 2 shows electrochemical performance test results of the aluminum fluorinated carbon primary cell obtained in Application Example 1. The test results show that the obtained aluminum fluorinated carbon primary cell exhibits a stable discharge plateau close to 1.1 V at a current density of 10 mA/g, with a discharge specific capacity of 839.03 mAh/g, demonstrating excellent discharge capacity and good electrochemical stability.

### Application Example 2

The alkaline ionic liquid electrolyte described in Implementation Example 1 is applied to prepare an aluminum sulfur primary cell, which uses a Swagelok-type sealing structure. The separator, the positive electrode, and the negative electrode are cut according to the cell model design. The preparation method of the positive electrode material is as follows: Ketjen black (KB) and sulfur powder are weighed in a mass ratio of 2:3, and grinded evenly; the obtained mixture is placed in a mold, shaped with a hydraulic press, sealed and placed in an oven with a temperature of 160 °C for melting to prepare KB/S. After 12 hours, the mixture is taken out and grinded for later use. The KB/S, the conductive carbon black, and the PTFE with a mass ratio of 7:2:1 are used for preparing the positive electrode sheet, with aluminum sheet used as the negative electrode, the organic ionic liquid prepared in Implementation Example 1 used as the liquid electrolyte, and the glass fiber used as the separator.

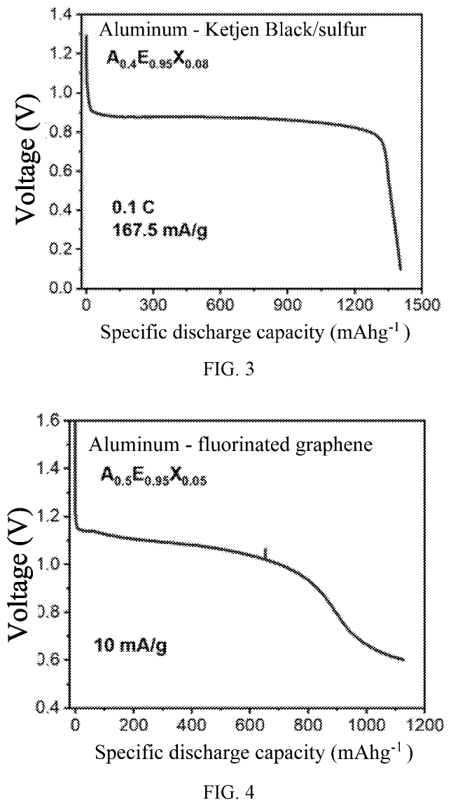

FIG. 3 shows electrochemical performance test results of aluminum sulfur primary cell prepared in Application Example 2. The results show that at a current density of 0.1 C (167.5 mA/g, the same below), the discharge specific capacity of the obtained cell reaches 1405 mAh/g, which is close to the theoretical capacity of sulfur of 1675 mAh/g, exhibiting excellent discharge performance and a stable discharge plateau of 0.9 V.

According to electrochemical performance test results of Application Example 1 and Application Example 2, the aluminum primary cell based on alkaline ionic liquid electrolyte described in the present disclosure has high specific capacity and excellent discharge plateau, fully utilizing the capacity release of the positive electrode material, indicating that the positive electrode material has stable properties and thorough reaction in alkaline ionic liquid. The obtained alkaline ionic liquid electrolyte shows great potential for application in aluminum primary cell.

### Implementation Example 2

An alkaline ionic liquid electrolyte, the preparation method of which is roughly same as that in Implementation Example 1, with the only difference being that the molar ratio of AlCl₃, [EMIM]Cl, and LiCl is 0.5:0.95:0.05. The melting point of the obtained alkaline ionic liquid electrolyte is −30~−25 °C.

### Application Example 3

The alkaline ionic liquid electrolyte obtained in Implementation Example 2 is applied to prepare an aluminum fluorinated carbon primary cell, which uses a Swagelok-type sealing structure. The separator, the positive electrode, and the negative electrode are cut according to the cell model design, and the introduced positive electrode material is fluorinated graphene (CFₓ, x=1.07). At a temperature of 30 °C, CFₓ exhibits stable properties in this liquid electrolyte system. The specific preparation method of aluminum fluorinated carbon primary cell includes following steps: the preparation method of the positive electrode sheet of Application Example 3 is the same as that in Implementation Example 1, the aluminum sheet is used as the negative electrode, alkaline ionic liquid electrolyte obtained in Implementation Example 2 is used as the liquid electrolyte, and the glass fiber is used as the separator.

FIG. 4 shows electrochemical performance test results of aluminum fluorinated carbon primary cell obtained in Application Example 3. The results indicate that at a current density of 10 mA/g, the cell exhibits a stable discharge plateau close to 1.1 V, with a discharge specific capacity of 1126.82 mAh/g, demonstrating excellent discharge capacity and good electrochemical stability.

### Application Example 4

The alkaline ionic liquid electrolyte described in Implementation Example 2 is applied to prepare an aluminum sulfur primary cell, which uses a Swagelok-type sealing structure. The separator, the positive electrode, and the negative electrode are cut according to the cell model design. The preparation method of the positive electrode includes following steps: carbon nanotube and sulfur powder are weighed in a mass ratio of 2:3, and the carbon sulfur composite material is also prepared using the aforementioned melting method. The specific method is the same as that in Implementation Example 2.

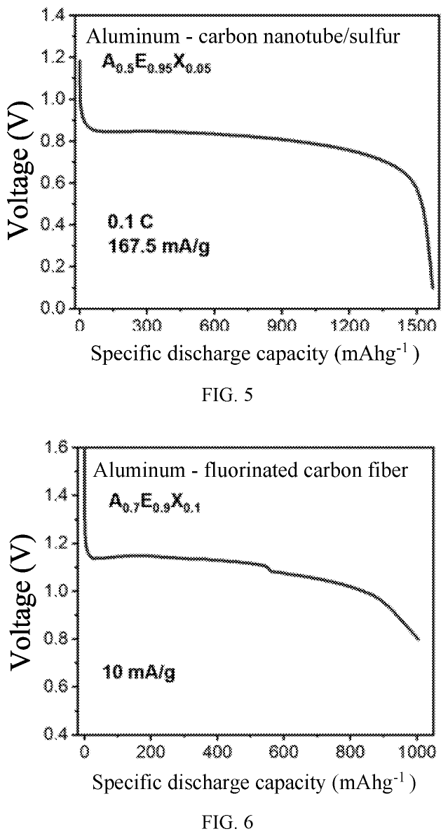

FIG. 5 shows electrochemical performances of aluminum carbon nanotube sulfur primary cell obtained in Application Example 4. The test data shows that the discharge plateau of this cell is close to 0.9 V, and the discharge specific capacity reaches 1571.42 mAh/g, demonstrating excellent electrochemical performances.

The excellent electrochemical performances of the aluminum carbon nanotube sulfur cell obtained in Application Example 4 can be further attributed to its carbon framework structure, which can provide efficient electronic conduction, abundant active material deposition sites, and stable host structure.

### Implementation Example 3

An alkaline ionic liquid electrolyte, the preparation method of which is roughly same as that in Implementation Example 1, with the only difference being the use of alkali metal salts LiCl and NaCl instead of some [EMIM]Cl. The molar ratio of the introduced AlCl₃, [EMIM]Cl, LiCl, and NaCl is 0.7:0.9:0.05:0.5. The melting point of the obtained alkaline ionic liquid electrolyte is −30~−25 °C.

### Application Example 5

The alkaline ionic liquid electrolyte obtained in Implementation Example 3 is applied to prepare an aluminum fluorinated carbon fiber primary cell, which uses a Swagelok-type sealing structure. The preparation method of this cell in Application Example 5 is identical to that in Implementation Example 1, with the only difference being fluorinated carbon fiber (x=0.97) used as the positive electrode material, which has stable properties in the obtained liquid electrolyte.

Constant current discharge tests are conducted on the aluminum fluorinated carbon fiber primary cell with organic ionic electrolyte obtained in Application Example 5. The results shown in FIG. 6 demonstrates that, at a current density of 10 mA/g, the aluminum fluorinated carbon fiber primary cell exhibits a discharge specific capacity of up to 1004 mAh/g and a stable discharge plateau of 1.1 V, demonstrating excellent discharge performance and electrochemical stability.

### Implementation Example 4

An alkaline ionic liquid electrolyte, the preparation method of which is roughly same as that in Implementation Example 1, with the only difference being the use of alkali metal salts LiCl and KCl instead of some [EMIM]Cl, and the molar ratio of the introduced AlCl₃, [EMIM]Cl, LiCl, and KCl is 0.7:0.9:0.05:0.05. The melting point of the obtained alkaline ionic liquid electrolyte is −30~−25 °C.

### Application Example 6

The alkaline ionic liquid electrolyte obtained in Implementation Example 4 is applied to prepare an aluminum sulfur primary cell, and the preparation method is basically the same as that in Implementation Example 4, with the only difference being the use of carbon nanotube sulfur composite material as the positive electrode material. The preparation method of the positive electrode is as follows: carbon nanotube and sulfur powder are weighed in a mass ratio of 2:3, and carbon sulfur composite material is prepared using the same melting method. The specific method is the same as that in Implementation Example 2.

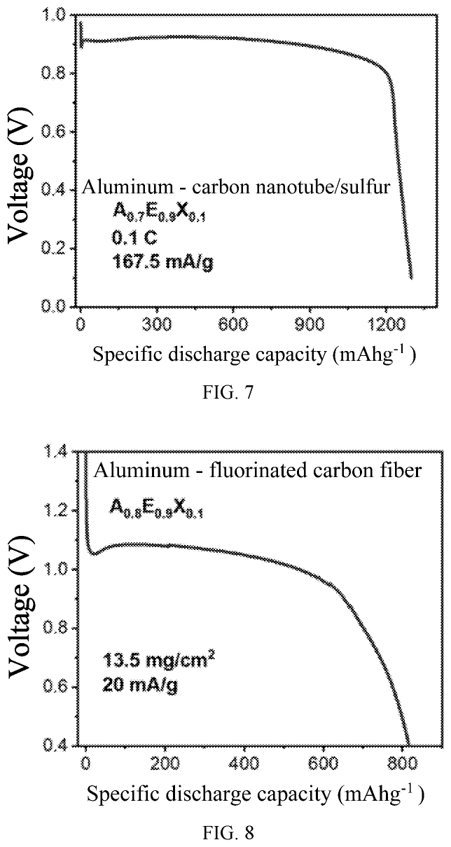

Conduct constant current discharge tests are conducted on the aluminum carbon fiber sulfur primary cell obtained in Application Example 6. As shown in FIG. 7, at a current density of 0.1 C (167.5 mA/g), the discharge specific capacity of this cell reaches 1300.01 mAh/g, exhibiting excellent discharge performance and a stable discharge plateau of 0.9 V.

The above results indicate that when the molar ratio of AlCl₃ to EMIC in the alkaline ionic liquid electrolyte is within the range of 0.4~0.8, the obtained aluminum fluorinated carbon primary cell and aluminum sulfur primary cell exhibit excellent electrochemical performances. In addition, the alkaline ionic liquid electrolyte exhibits good universality and can effectively adapt to various fluorinated carbon and sulfur cathode materials.

### Implementation Example 5

An alkaline ionic liquid electrolyte, the preparation method of which is roughly same as that in Implementation Example 1, with the only difference being the use of alkali metal salt KCl instead of a portion of [EMIM]Cl. The molar ratio of the introduced AlCl₃, [EMIM]Cl, and KCl is 0.8:0.9:0.1. The melting point of the obtained alkaline ionic liquid electrolyte is −25~−20 °C.

### Application Example 7

The alkaline ionic liquid electrolyte obtained in Implementation Example 5 is applied to prepare an aluminum fluorinated carbon fiber primary cell, which uses a Swagelok-type sealing structure. The cell preparation method used in Application Example 7 is identical to that in Implementation Example 1, with the only difference being the use of positive electrode sheet having a high loading of active material (fluorinated carbon fiber) (the loading amount is 13.5 mg/cm²).

As shown in FIG. 8, at a current density of 20 mA/g, the obtained aluminum fluorinated carbon fiber primary cell exhibits a stable discharge voltage plateau of 1.1 V, with a discharge specific capacity of 816.47 mAh/g.

### Implementation Example 6

An alkaline ionic liquid electrolyte, the preparation method of which is roughly same as that in Implementation Example 1, with the only difference being the use of alkali metal salts LiCl, NaCl, and KCl instead of a portion of [EMIM]Cl, and the molar ratio of the introduced AlCl₃, [EMIM]Cl, LiCl, NaCl, and KCl is 0.8:0.9:0.05:0.02:0.03. The melting point of the obtained alkaline ionic liquid electrolyte is −25~−20 °C.

### Application Example 8

The alkaline ionic liquid electrolyte obtained in Implementation Example 6 is applied to prepare an aluminum fluorinated carbon primary cell, the preparation method in this Application Example 8 is basically same as that in Implementation Example 1. The positive electrode material is fluorinated carbon fiber (with a fluorine-to-carbon ratio (F/C) of 0.89).

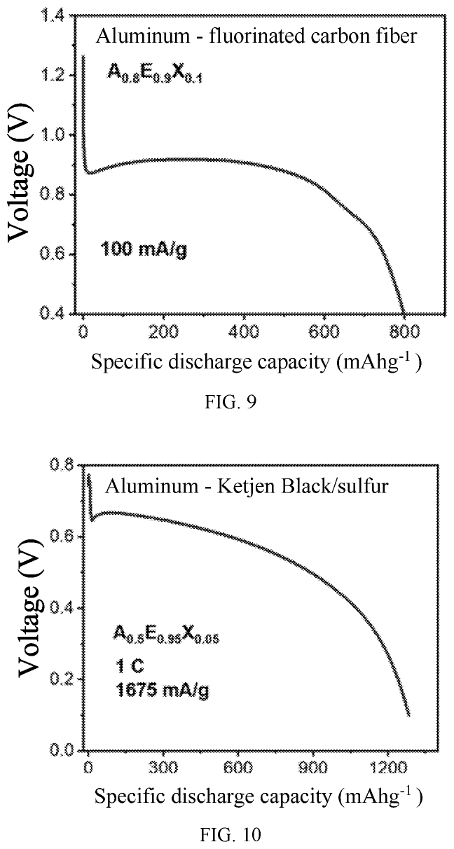

As shown in FIG. 9, at a current density of 100 mA/g, the obtained aluminum fluorinated carbon fiber primary cell exhibits a stable discharge voltage plateau of 0.9 V, with a discharge specific capacity of 800 mAh/g, indicating excellent rate performance of this cell.

### Application Example 9

The alkaline ionic liquid electrolyte obtained in Implementation Example 2 is applied to prepare aluminum sulfur primary cell, the preparation method of the aluminum sulfur primary cell is basically same as that in Implementation Example 1, and the positive electrode material used is the same as that in Application Example 2.

As shown in FIG. 10, at a high current density of 1 C (1675 mA/g), the Al-KB/S primary cell can still maintain a high voltage plateau, with a discharge specific capacity of 1283.51 mAh/g and excellent rate performances.

### Comparison Example 1

An acidic ionic liquid electrolyte, the preparation method of which is roughly same as that in Implementation Example 1, with the only difference being the molar ratio of AlCl₃ and 1-methyl-3-ethylimidazole chloride (EMICl) of 1.3:1 and a same test temperature of 30 °C. The freezing point of the obtained acidic ionic liquid electrolyte is about −1 °C.

The acidic ionic liquid electrolyte obtained from Comparison Example 1 is applied to prepare aluminum fluorinated carbon fiber primary cell, which uses a Swagelok-type sealing structure. The specific preparation method of this cell is the same as that in Implementation Example 1.

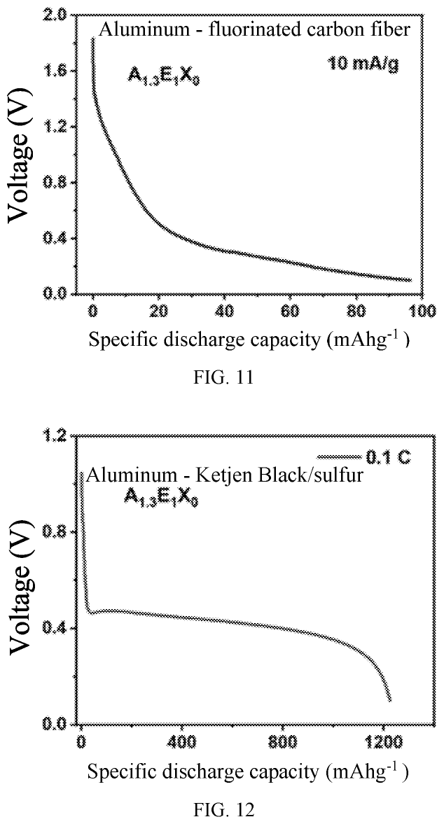

Conduct constant current discharge tests are conducted on the aluminum fluorinated carbon fiber primary cell prepared in Comparison Example 1. The same current density of 10 mA/g is used for testing, and as shown in FIG. 11, this cell exhibits poor discharge capacity and plateau.

Compared with Implementation Example 1, it can be seen that electrochemical performances of aluminum fluorinated carbon cell using acidic electrolyte systems are poor at the same current density and test temperature.

### Comparison Example 2

The acidic ionic liquid electrolyte obtained from Comparison Example 1 is applied to prepare an aluminum sulfur primary cell, which uses a Swagelok-type sealing structure, and the preparation method of this cell is identical to that in Implementation Example 1.

As shown in FIG. 12, at a current density of 0.1 C (167.5 mAh/g), the discharge voltage plateau of Al-KB/S primary cell using aluminum chloride (AlCl₃) and 1-ethyl-3-methylimidazolium chloride (EMIC) in a molar ratio of 1.3:1 is 0.4 V, significantly lower than the discharge voltage plateau of the cell using alkaline electrolyte.

### Comparison Example 3

A neutral ionic liquid electrolyte, the preparation method of which is roughly same as that in Implementation Example 1, with the only difference being the weighed AlCl₃ and 1-methyl-3-ethylimidazole chloride (EMICl) in a molar ratio of 1:1 and the same test temperature of 30 °C. The melting point of the obtained neutral ionic liquid electrolyte is about −1 °C.

The neutral ionic liquid electrolyte obtained from Comparison Example 3 is applied to prepare an aluminum fluorinated carbon fiber primary cell, which uses a Swagelok-type sealing structure. The specific preparation method of this cell is the same as that in Implementation Example 1.

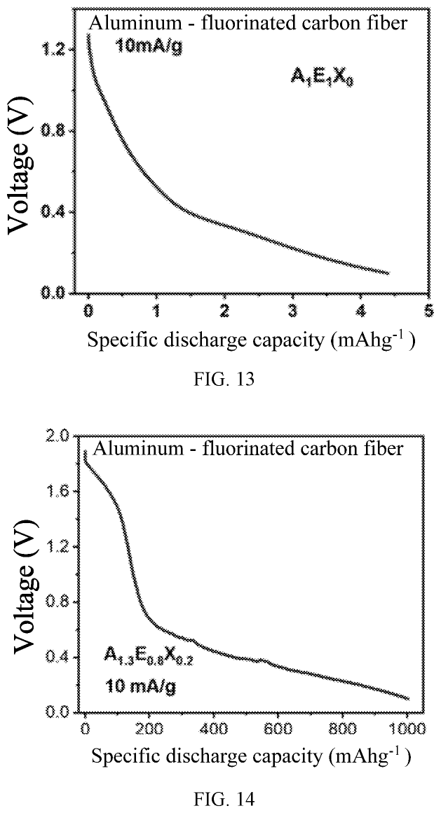

Conduct constant current discharge tests are conducted on aluminum fluorinated carbon fiber primary cell prepared in Comparison Example 3. The same current density of 10 mA/g is used for testing, and as shown in FIG. 13, this cell exhibits poor discharge capacity and plateau.

### Comparison Example 4

An acidic ionic liquid electrolyte, the preparation method of which is roughly same as that in Implementation Example 1, with the only difference being the use of alkali metal salt KCl instead of a portion of [EMIM]Cl, and the molar ratio of the introduced AlCl₃, [EMIM]Cl, and KCl is 1.3:0.8:0.2.

The acidic ionic liquid electrolyte obtained from Comparison Example 4 is applied to prepare an aluminum fluorinated carbon fiber primary cell, which uses a Swagelok-type sealing structure. The specific preparation method of this cell is the same as that in Implementation Example 1.

Conduct constant current discharge tests are conducted on aluminum fluorinated carbon fiber primary cell prepared in Comparison Example 4. The same current density of 10 mA/g is used for testing, and as shown in FIG. 14, compared to the A_{1.3}E₁X₀ electrolyte, the introduction of alkali metal cation K⁺ significantly increases the discharge specific capacity to reach 1003.18 mAh/g, and also increases the voltage plateau (0.2~0.4 V), indicating that the introduction of alkali metal cations can promote the improvement of kinetic effects to a certain extent. However, there is still a significant gap compared to the voltage plateau (1.1 V) of the aluminum fluorinated carbon cell based on alkaline liquid electrolyte described in the present disclosure.

### Comparison Example 5

An alkaline ionic liquid electrolyte, the preparation method of which is roughly same as that in Implementation Example 1, with the only difference being the molar ratio of aluminum chloride (AlCl₃) to 1-methyl-3-ethylimidazole chloride (EMICl) of 0.3:1. The aluminum chloride (AlCl₃) is added to the 1-methyl-3-ethylimidazole chloride in portions over 30~60 minutes at room temperature, and stirred thoroughly (200~600 rpm). However, after thoroughly stirring, some of the 1-methyl-3-ethylimidazole chloride (EMICl) still remains solid, indicating that the liquid electrolyte cannot be mixed evenly when there is too little aluminum chloride (AlCl₃), and the liquid electrolyte cannot be effectively applied in preparation of aluminum primary cell.

The constant current discharge performance tests are conducted on the aluminum primary cells having ionic liquid electrolyte prepared in each of the aforementioned implementation examples and comparison examples, and the test results are shown in Table 1.

### Table 1 Discharge Performance Test Results of Aluminum Primary Cells Prepared in Application Examples and Comparison Examples

| | Components of liquid electrolyte | | |
|---|---|---|---|
| | AlCl:EMICL:XCl | Active | Current density, discharge |
| Groups | (Li, Na, K) | components | capacity, and plateau |
| Application | A_{0.4}E_{0.95}X_{0.08} | Fluorinated | 10 mA/g, 839.03 mAh/g, 1.1 V |
| Example 1 | | graphite | |
| Application | A_{0.4}E_{0.95}X_{0.08} | Ketjen black - | 0.1 C, 1405 mAh/g, 0.9 V |
| Example 2 | | sulfur | |
| Application | A_{0.5}E_{0.95}X_{0.05} | Fluorinated | 10 mA/g, 1126.82 mAh/g, 1.1 V |
| Example 3 | | graphene | |
| Application | A_{0.5}E_{0.95}X_{0.05} | Carbon nanotube - | 0.1 C, 1571.42 mAh/g, 0.9 V |
| Example 4 | | sulfur | |
| Application | A_{0.7}E_{0.9}X_{0.1} | Fluorinated carbon | 10 mA/g, 1004 mAh/g, 1.1 V |
| Example 5 | | fiber | |
| Application | A_{0.7}E_{0.9}X_{0.1} | Carbon nanotube - | 0.1 C, 1300.01 mAh/g, 0.9 V |
| Example 6 | | sulfur | |
| Application | A_{0.8}E_{0.9}X_{0.1} | Fluorinated carbon | 20 mA/g, 816.47 mAh/g, 1.1 V |
| Example 7 | | fiber | |
| Application | A_{0.8}E_{0.9}X_{0.1} | Fluorinated carbon | 100 mA/g, 800 mAh/g, 0.9 V |
| Example 8 | | fiber | |
| Application | A_{0.5}E_{0.95}X_{0.05} | Ketjen black - | 1 C, 1283.51 mAh/g, 0.6~0.7 V |
| Example 9 | | sulfur | |
| Comparison | A_{1.3}E₁X₀ | Fluorinated carbon | 10 mA/g, 94 mAh/g, 0.1~0.4 V |
| Example 1 | | fiber | |
| Comparison | A_{1.3}E₁X₀ | Ketjen black - | 0.1 C, 1224 mAh/g, 0.4 V |
| Example 2 | | sulfur | |
| Comparison | A₁E₁X₀ | Fluorinated carbon | 10 mA/g, 4 mAh/g, 0.1~0.4 V |
| Example 3 | | fiber | |
| Comparison | A_{1.3}E_{0.8}X_{0.2} | Fluorinated carbon | 10 mA/g, 1003.18 mAh/g, 0.5 V |
| Example 4 | | fiber | |

It can be seen from Table 1 that the positive electrode material in the alkaline liquid electrolyte systems of the aluminum primary cells prepared in each implementation example has high discharge specific capacity and a very stable discharge plateau.

In Comparison Examples 1 and 2, the ionic liquid electrolyte is acidic, resulting in extremely low discharge capacity and no obvious discharge plateau, and unstable cell performance, indicating that the reaction activity of the positive electrode material is lower, leading to incomplete capacity release.

In Comparison Example 3, the ionic liquid electrolyte is neutral, with most of anions in the liquid electrolyte being AlCl₄⁻ and lacking Cl⁻, resulting in the inability of the reaction in the negative electrode side to proceed and poor discharge performance.

Although the present disclosure has been illustrated through specific embodiments, it should be understood that these embodiments are only used to clarify technical solutions and do not constitute limitations on the present disclosure. Those skilled in this field should understand that modifications or equivalent substitutions can be made to the technical solutions in the embodiments without departing from the spirit and scope of the present disclosure, and these modifications or substitutions will not exceed the technical scope of the present disclosure. Therefore, the attached claims should include all such modifications and substitutions.

What is claimed is:

1. An alkaline ionic liquid electrolyte, generated by a coordination reaction of aluminum chloride with Cl⁻ in 1-ethyl-3-methylimidazolium chloride and alkali metal chloride salt; wherein a general formula for raw material components of the alkaline ionic liquid electrolyte is AₐE_{b}X_{c}, wherein A is the aluminum chloride, E is the 1-ethyl-3-methylimidazolium chloride, and X is the alkali metal chloride salt; a is a molar ratio of the aluminum chloride, b is the molar ratio of the 1-ethyl-3-methylimidazolium chloride, and c is the molar ratio of the alkali metal chloride salt; and wherein 0.4≤a≤0.8, 0.9≤b≤1, and 0.02≤c≤0.1; and
a melting point of the alkaline ionic liquid electrolyte is −30~−20 °C.

2. The alkaline ionic liquid electrolyte according to claim 1, wherein the alkali metal chloride salt is at least one of LiCl, NaCl, KCl, RbCl, and CsCl.

3. The alkaline ionic liquid electrolyte according to claim 1, wherein in the alkaline ionic liquid electrolyte, anions comprise Cl⁻ and AlCl₄⁻, and cations comprise [EMIM]⁺ and alkali metal ions.

4. A preparation method of the alkaline ionic liquid electrolyte according to claim 1, comprising: adding the aluminum chloride to a mixture of the 1-ethyl-3-methylimidazolium chloride and the alkali metal chloride salt under conditions of inert atmosphere, anhydrous and stirring, and stirring and reacting to form a clear liquid, thus obtaining the alkaline ionic liquid electrolyte.

5. The preparation method according to claim 4, wherein a rate for stirring is 200~600 rpm.

6. A preparation method of the alkaline ionic liquid electrolyte according to claim 2, comprising: adding the aluminum chloride to a mixture of the 1-ethyl-3-methylimidazolium chloride and the alkali metal chloride salt under conditions of inert atmosphere, anhydrous and stirring, and stirring and reacting to form a clear liquid, thus obtaining the alkaline ionic liquid electrolyte.

7. The preparation method according to claim 6, wherein a rate for stirring is 200~600 rpm.

8. A preparation method of the alkaline ionic liquid electrolyte according to claim 3, comprising: adding the aluminum chloride to a mixture of the 1-ethyl-3-methylimidazolium chloride and the alkali metal chloride salt under conditions of inert atmosphere, anhydrous and stirring, and stirring and reacting to form a clear liquid, thus obtaining the alkaline ionic liquid electrolyte.

9. The preparation method according to claim 8, wherein a rate for stirring is 200~600 rpm.

10. An aluminum primary cell based on the alkaline ionic liquid electrolyte according to claim 1, comprising following key components: an aluminum negative electrode, the alkaline ionic liquid electrolyte, a separator, and a positive electrode.

11. The aluminum primary cell according to claim 10, wherein the aluminum primary cell is an aluminum fluorinated carbon primary cell or an aluminum sulfur primary cell; wherein a positive electrode material of the aluminum fluorinated carbon primary cell is a fluorinated carbon based positive electrode material, and wherein the positive electrode material of the aluminum sulfur primary cell is a sulfur-containing conductive positive electrode material.

12. The aluminum primary cell according to claim 10, wherein an operating temperature range of the aluminum primary cell is −10~100 °C.

13. An aluminum primary cell based on the alkaline ionic liquid electrolyte according to claim 2, comprising following key components: an aluminum negative electrode, the alkaline ionic liquid electrolyte, a separator, and a positive electrode.

14. The aluminum primary cell according to claim 13, wherein the aluminum primary cell is an aluminum fluorinated carbon primary cell or an aluminum sulfur primary cell; wherein a positive electrode material of the aluminum fluorinated carbon primary cell is a fluorinated carbon based positive electrode material, and wherein the positive electrode material of the aluminum sulfur primary cell is a sulfur-containing conductive positive electrode material.

15. The aluminum primary cell according to claim 13, wherein an operating temperature range of the aluminum primary cell is −10~100 °C.

16. An aluminum primary cell based on the alkaline ionic liquid electrolyte according to claim 3, comprising following key components: an aluminum negative electrode, the alkaline ionic liquid electrolyte, a separator, and a positive electrode.

17. The aluminum primary cell according to claim 16, wherein the aluminum primary cell is an aluminum fluorinated carbon primary cell or an aluminum sulfur primary cell; wherein a positive electrode material of the alkaline fluorinated carbon primary cell is a fluorinated carbon based positive electrode material, and wherein the positive electrode material of the aluminum sulfur primary cell is a sulfur-containing conductive positive electrode material.

18. The aluminum primary cell according to claim 16, wherein an operating temperature range of the aluminum primary cell is −10~100 °C.
